(19) United States
(12) Patent Application Publication
(10) Pub. No.: US 2022/0408022 A1
(43) Pub. Date: Dec. 22, 2022

(54) IMAGE PROCESSING APPARATUS, IMAGE PROCESSING METHOD, AND STORAGE MEDIUM

(71) Applicant: CANON KABUSHIKI KAISHA, Tokyo (JP)

(72) Inventors: Naoka Maruhashi, Tokyo (JP); Seiya Ohta, Kanagawa (JP); Naoki Maruyama, Tokyo (JP)

(21) Appl. No.: 17/842,048

(22) Filed: Jun. 16, 2022

(30) Foreign Application Priority Data
Jun. 22, 2021 (JP) 2021-102904
Jun. 22, 2021 (JP) 2021-103255
Dec. 27, 2021 (JP) 2021-212556
Jan. 19, 2022 (JP) 2022-006392

(51) Int. Cl. H04N 5/232; G06T 5/00

(52) U.S. Cl. CPC H04N 5/23267; G06T 5/003; H04N 5/23258

(57) ABSTRACT

An image processing apparatus comprises: an acquisition unit for acquiring each of motion vector amounts of video signals each obtained from a plurality of camera units; a determination unit for determining whether or not each of the motion vector amounts is appropriate; and a control unit for performing image blur correction for the video signal for which the motion vector amount determined to be not appropriate has been obtained by using the motion vector amount determined to be appropriate if it is determined by the determination unit that at least one of the motion vector amounts is not appropriate, and to perform image blur correction for the video signals by sharing any one of the motion vector amounts determined to be appropriate by the determination unit or by using the respective motion vector amounts if it is determined by the determination unit that the respective motion vector amounts are appropriate.

### BACKGROUND OF THE INVENTION

### Field of the Invention

The present invention relates to an image processing apparatus that processes video signals from a plurality of camera units, an image processing method, and the like.

### Description of the Related Art

In recent years, image pickup apparatuses having a plurality of camera units built in a single case, such as a multi-view camera, have been used. In such image pickup apparatus, since panning/tilting driving can be performed manually or automatically for each camera unit, images can be captured while bringing each camera unit close to each other.

However, when the camera units are brought close to each other, each angle of view captured by each camera unit needs to be adjusted narrower to reduce the overlap of the capturing region of the camera units.

When the shooting angle of each camera unit is adjusted narrower, even a slight shaking becomes noticeable, and it is effective that image blur is reduced by calculating an image blur correction amount based on image blur signals acquired by the image pickup apparatus and using an electronic image blur correction function for changing an electronic cut-out position.

However, if there is a difference in the presence or absence of a moving object in the video image captured by each camera unit, or a difference in the moving speed of the moving object, some camera units incorrectly detect the amount of motion vector acquired by each camera unit. Additionally, in the electronic image blur correction, a cut-out range is set in advance, and if the camera is installed in a location where the shaking amount is high, the cut-out amount is insufficient, and thereby a remaining image blur occurs.

Additionally, some camera units incorrectly detect a motion vector amount acquired by each camera unit also due to the differences in the image quality setting set for each camera unit.

For example, when an image blur correction amount to be used in electronic image blur correction is calculated by using a motion vector amount, a remaining image blur occurs in the camera unit that has acquired the incorrect motion vector amount. In contrast, in the camera unit that has acquired an appropriate motion vector amount, video images in which no remaining image blur occurs are obtained.

Accordingly, when the video images of the respective camera units are displayed adjacent to each other and jointed, the joint portions of the adjacent video images of the respective camera units deviate from each other and do not match, as a result, the video image appears unnatural.

In Japanese Patent Application Laid-Open Publication No. 2012-142837, a camera shake correction amount signal indicating a camera shake amount detected by a first image pickup apparatus is supplied to a second image pickup apparatus, and a camera shake correction amount signal indicating a camera shake amount detected by the second image pickup apparatus is supplied to the first image pickup apparatus. Subsequently, in the first image pickup apparatus and the second image pickup apparatus, camera shake correction is performed based on a camera shake amount, which is the average of a camera shake amount detected by the own apparatus and a camera shake amount detected by the other apparatus, and thereby a high-quality three-dimensional image with less 3D-sickness can be captured.

In Japanese Patent Application Laid-Open Publication No. 2004-274701, position and posture information of a virtual image pickup apparatus is obtained by using the position and posture information of a plurality of image pickup apparatuses, the overall conversion for reducing the shaking of the virtual image pickup apparatus is calculated, and based on the calculated overall conversion, an individual conversion of an individual image pickup apparatus for reducing the shaking of a plurality of the image pickup apparatuses is calculated.

By generating a panoramic video image by connecting a plurality of images to which the calculated individual conversion has been applied, the image blur of the panoramic video image can be reduced.

However, in Japanese Patent Application Laid-Open Publication No. 2012-142837, since image blur correction in each image pickup apparatus is performed by using an average image blur amount between the first image pickup apparatus and the second image pickup apparatus, remaining image blur that has a different amount between the image pickup apparatuses occurs. Therefore, if the remaining image blur amounts are different, the joint portions between the adjacent video images deviate from each other, and as a result, the video image appears unnatural.

In the technique disclosed in Japanese Patent Application Laid-Open Publication No. 2004-274701, only the position and posture information is used and no consideration is taken to which camera unit provides an appropriate image blur correction amount, and as a result, an incorrect image blur correction amount may be calculated. Therefore, there is still a drawback in that the joint portion of the video image is unnatural.

### SUMMARY OF THE INVENTION

An object of the present invention is to provide an image processing apparatus that enables joint portions between video images each obtained from a plurality of camera units to become less conspicuous, in view of the above drawback.

In one aspect of the present invention, an image processing apparatus comprises: at least one processor or circuit configured to function as: an acquisition unit configured to acquire each of motion vector amounts of video signals each obtained from a plurality of camera units; a determination unit configured to determine whether or not each of the motion vector amounts is appropriate; and a control unit configured to perform image blur correction for the video signal for which the motion vector amount determined to be not appropriate has been obtained by using the motion vector amount determined to be appropriate if it is determined by the determination unit that at least one of the motion vector amounts is not appropriate, and to perform image blur correction for the plurality of video signals by sharing any one of the motion vector amounts determined to be appropriate by the determination unit or perform image blur correction for the plurality of video signals by using the respective motion vector amounts if it is determined by the determination unit that the respective motion vector amounts are appropriate.

Further features of the present invention will become apparent from the following description of embodiments with reference to the attached drawings.

### BRIEF DESCRIPTION OF THE DRAWINGS

FIG. 1 is a functional block diagram of an image processing apparatus 1000 according to the first embodiment.

FIG. 2 is a flowchart showing the matching of motion vector amount for each camera unit according to the first embodiment.

FIG. 3 is a flowchart showing the calculation of image blur correction amounts according to a user selection mode in step S206 according to the first embodiment.

FIG. 4A and 4B illustrate examples of video images from each camera unit, which are displayed adjacent to each other according to the first embodiment.

FIG. 5 is a determination flowchart showing the determination whether or not the motion vector amount for each camera unit is appropriate according to the second embodiment.

FIG. 6 is a flowchart showing the confirmation of image quality settings of each camera unit according to the third embodiment.

FIG. 7 is a flowchart showing the determination of an appropriate motion vector amount according to a noise amount and a shutter speed of each camera unit according to the fourth embodiment.

FIG. 8 is a flowchart showing the determination of an appropriate motion vector amount according to the accuracy of the motion vector of each camera unit according to the fifth embodiment.

FIG. 9 is a flow chart showing the weighting of motion vector of each camera unit according to the sixth embodiment.

FIG. 10 is a flowchart showing the calculation of an image blur correction amount according to the seventh embodiment.

FIG. 11 is a flowchart showing the determination of a motion vector amount according to the eighth embodiment.

FIG. 12 is a flowchart showing the calculation of the image blur correction amount according to the ninth embodiment.

FIG. 13 is a block diagram showing an example of a configuration of the image processing apparatus 1000 according to the tenth embodiment.

FIG. 14 is a flowchart showing the processing according to the tenth embodiment.

FIG. 15 is a flowchart showing the details of step S203 in FIG. 14.

FIG. 16 is a block diagram showing an example of a detailed configuration of an image blur correction amount calculation unit.

FIG. 17A and 17B show examples of waveform signals corresponding to remaining image blur.

FIG. 18 is a flowchart showing the process according to the eleventh embodiment.

FIG. 19 is a flowchart showing the process according to the twelfth embodiment.

FIG. 20 is a flowchart showing the process according to the thirteenth embodiment.

FIG. 21 is a flowchart showing the process according to the fourteenth embodiment.

FIG. 22 is a flowchart showing the process according to the fifteenth embodiment.

FIG. 23 is a flowchart showing the process according to the sixteenth embodiment.

### DESCRIPTION OF THE EMBODIMENTS

Hereinafter, with reference to the accompanying drawings, favorable modes of the present invention will be described using embodiments. In each diagram, the same reference signs are applied to the same members or elements, and duplicate description will be omitted or simplified.

Additionally, in the embodiments, an example of an image processing apparatus that is applied to a network camera will be described. However, an image processing apparatus includes digital still cameras, digital movie cameras, smartphones, personal computers, in-vehicle cameras, drone cameras, robots, and other electronic devices.

### <First Embodiment>

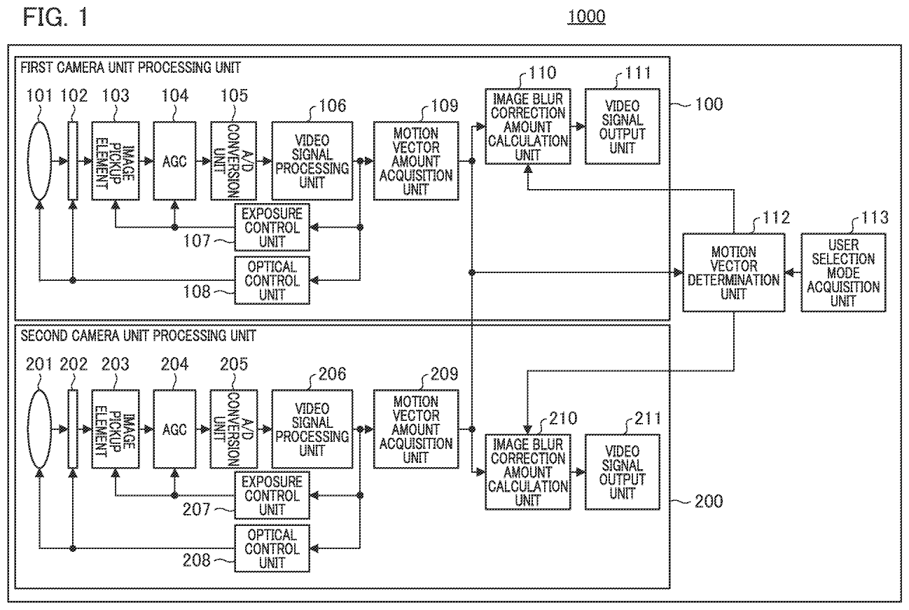

FIG. 1 is a functional block diagram of an image processing apparatus 1000 in the first embodiment.

A part of the functional block shown in FIG. 1 is realized by causing a computer serving as a control unit (not illustrated) included in the image processing apparatus 1000 to execute a computer program stored in a memory serving as a storage medium (not illustrated). However, some or all of these may be realized by hardware. A dedicated circuit (ASIC), a processor (reconfigurable processor, DSP) or the like can be used as hardware.

The image processing apparatus 1000 in FIG. 1 includes a first camera unit 100 and a second camera unit 200. Since reference numerals 101 to 111, which are function units of the first camera unit 100, and reference numerals 201 to 211, which are function units of the second camera unit 200, have the same configuration, the functional units of the first camera unit will be described below.

A lens group 101 of the first camera unit 100 is an optical system for imaging light from an object onto an image pickup element 103. The lens group 101 includes a focus lens for focusing on an object, a zoom lens for adjusting an angle of view, and the like.

An object image that enters into the camera through the lens group 101 passes through an optical filter 102, for example, an infrared cut filter IRCF, and is incident to the image pickup element 103.

The object image through the lens group 101 passes through a color filter with a predetermined pattern arranged on the light receiving surface of the image pickup element 103, is photoelectrically converted by each pixel of the image pickup element 103, and the object image is output as an analog image signal.

Gain control is performed on an image signal output from the image pickup element 103 by an AGC (Auto Gain Control) 104 for level adjustment, and the signal is converted into a digital image signal by an A/D conversion unit 105.

In a video signal processing unit 106, predetermined processing is performed on the digital image signal from the A/D conversion unit 105 and a video image signal consisting of a luminance signal and a color signal is output, and various parameters for performing camera control are generated.

The various parameters for performing camera control include parameters used for aperture control, focusing control, and white balance control for adjusting color tone.

An exposure control unit 207 calculates the luminance information in the capturing screen based on the luminance information serving as parameters that are output from the video signal processing unit 106 and controls the aperture and the AGC 104 so that the captured image is adjusted at a desired brightness.

An optical control unit 108 extracts a high-frequency component from the video image signals generated by the video signal processing unit 106 for focus control. Subsequently, the optical control unit 108 controls the lens group 101 so that the focus evaluation value is maximized, by using the value of the high-frequency component as the focus information (focus evaluation value). The optical control unit 108 also controls the insertion and removal of the optical filter 102 according to the luminance level.

A motion vector amount acquisition unit 109 acquires a motion vector amount of the camera unit based on the signals output from the video signal processing unit 106. The motion vector amount acquisition unit 109 acquires motion vector amount of each of a plurality of camera units based on the video signal obtained from each of the camera units.

A motion vector determination unit 112 determines whether or not motion vector amounts acquired by the motion vector amount acquisition units 109 and 209 of the first camera unit 100 and the second camera unit 200 are respectively appropriate. Based on the determination result of whether or not the motion vector amount of each camera unit is appropriate and the user selection mode obtained by the user selection mode acquisition unit 113, the motion vector determination unit 112 determines a motion vector amount to be used by each camera unit. Here, the motion vector determination unit 112 determines whether or not the respective motion vector amounts are appropriate.

The image blur correction amount calculation unit 110 of each camera unit determines an image blur correction amount by using the motion vector amount determined by the motion vector determination unit 112.

The video signal output unit 111 changes a cut-out position of an image from an image memory (not illustrated) according to the image blur correction amount calculated by the image blur correction amount calculation unit 110, and outputs a video image to which electronic image blur correction has been performed.

Here, the video signal output unit 111 functions as an output means that outputs video images obtained by correcting the video signal each obtained from the camera units to an external device together with the video signal output unit 211.

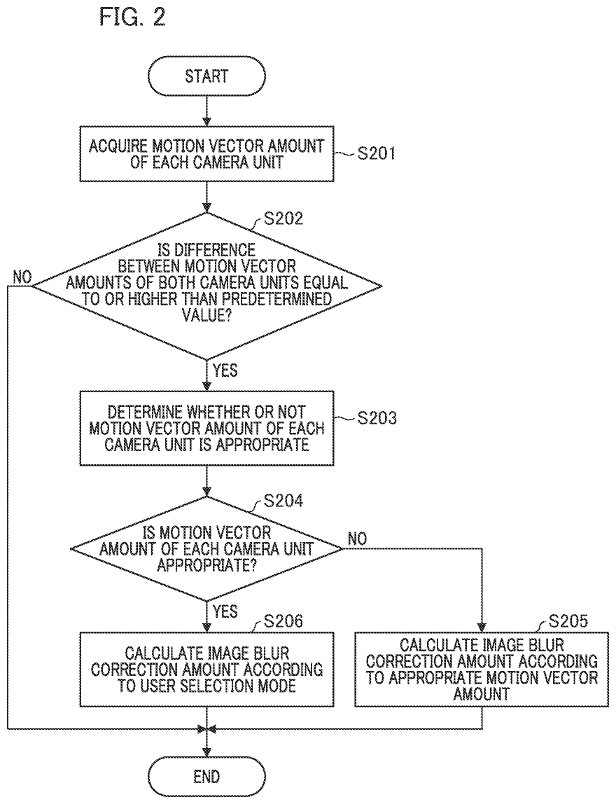

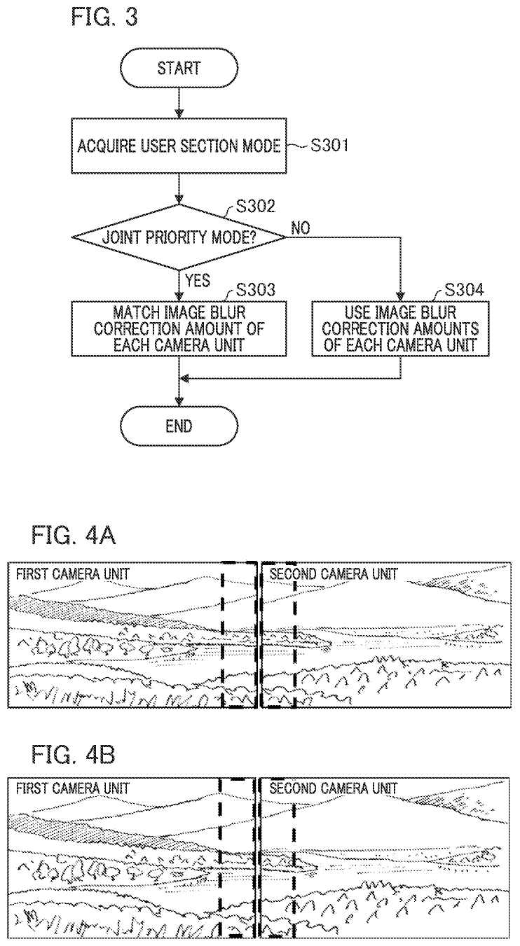

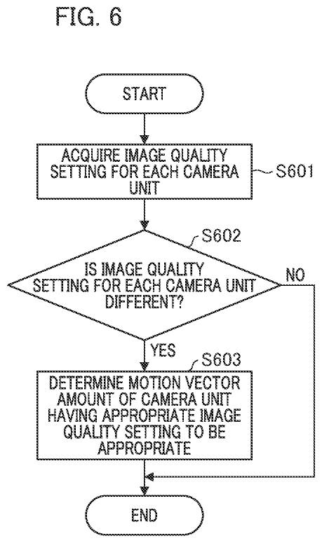

FIG. 2 is a flowchart showing the matching of the motion vector amounts of the respective camera units in the first embodiment, and the determination of the motion vector amount to be used in each camera unit in the first embodiment of the present invention will be described with reference to FIG. 2. Each of the processes in the flowchart in FIG. 2 is performed by causing a computer serving as a control unit (not illustrated) included in the image processing apparatus 1000 to execute a computer program stored in a memory serving as a storage medium (not illustrated). The same applies to the flowcharts of FIG. 3, FIG. 4, and FIG. 6 to FIG. 12.

First, in step S201 in FIG. 2, an acquisition step for acquiring a motion vector amount of each camera unit is executed. In this embodiment, each camera unit indicates the first camera unit 100 and the second camera unit 200. The motion vector amount can be acquired by obtaining a background difference from the previous frame or by performing the matching of feature points.

In step S202, whether or not the difference between the motion vector amount of the first camera unit 100 and the motion vector amount of the second camera unit 200 acquired in step S201 is equal to or higher than a predetermined value is determined.

When the result of the determination indicates that the difference between the motion vector amount of the first camera unit 100 and the motion vector amount of the second camera unit 200 is not equal to or higher than the predetermined value (NO), the process ends without any further process in FIG. 2 by each camera unit.

This is because when the difference in the motion vector amount between the first camera unit 100 and the second camera unit 200 is quite small, the difference itself in the final image blur correction amount calculated by using the motion vector amount also becomes quite small. Specifically, when the video images of the respective camera units are arranged adjacent to each other, connected, and displayed, the video images appear to be still because image blur correction has been performed to both images, and the deviation between the joint portions is quite small, less conspicuous, and not unnatural.

In contrast, when the result of the determination in step S202 indicates that the difference between the motion vector amount of the first camera unit 100 and the motion vector amount of the second camera unit 200 is equal to or higher than the predetermined value (YES), the process proceeds to step S203. Subsequently, whether or not the motion vector amount acquired from the first camera unit 100 and the motion vector amount acquired from the second camera unit 200 are appropriate is determined.

Step S203 functions as a determination unit for determining whether or not each motion vector amount is appropriate. Further, in the first embodiment, the determination in step S203 is made to be appropriate if at least one of the correctness, accuracy, and reliability of the motion vector is higher than a predetermined threshold. However, as will be described below, the motion vectors obtained from the plurality of camera units may be compared with a predetermined determination standard, and a motion vector having a relatively high degree of appropriateness may be determined to be appropriate.

If it is determined in the determination step of step S204 that the motion vector amount of any one of the first camera unit 100 and the second camera unit 200 is not appropriate, the process proceeds to step S205. Subsequently, the camera unit that has obtained the appropriate motion vector amount serves as the appropriate camera unit, the motion vector amount acquired from the appropriate camera unit is shared, and an image blur correction amount for both camera units is calculated.

That is, when the determination unit determines that at least one of the motion vector amounts is not appropriate, image blur correction is performed on the image signal for which the motion vector amount determined to be not appropriate is obtained by using the motion vector amount determined to be appropriate.

When the motion vector amount of the video signal acquired by the first camera unit 100 is not appropriate and the motion vector amount of the video signal acquired by the second camera unit 200 is appropriate, image blur correction amount calculation is performed by using the motion vector amount acquired by the second camera unit 200.

When the motion vector amount of the video signal acquired by the second camera unit 200 is not appropriate and the motion vector amount of the video signal acquired by the first camera unit 100 is appropriate, image blur correction amount calculation is performed by using the motion vector amount acquired by the first camera unit 100.

That is, for the video signal determined by the determination unit that the motion vector amount is not appropriate, image blur correction is performed by using the motion vector amount of the video signal that has been determined that the motion vector amount is appropriate.

When it is determined in step S204 that the motion vector amounts of the first camera unit 100 and the second camera unit 200 are appropriate, the image blur amounts are significantly different between the camera units, and an image blur correction amount is calculated according to the user selection mode (step S206).

FIG. 3 is a flowchart showing image blur correction amount calculation according to the user selection mode in step S206 in the first embodiment, and the user selection mode will be described with reference to FIG. 3.

In step S301 in FIG. 3, the user selection mode is obtained, and whether or not the obtained user selection mode is the “joint priority” mode is determined (step S302).

The “joint priority” mode is a mode for providing a natural appearance in which the deviation at the joint portion is less conspicuous when the video image of the first camera unit 100 and the video image of the second camera unit 200 are displayed arranged adjacent to each other.

When the result of the determination in step S302 indicates that the “joint priority” mode has been selected by the user (YES), the deviation at the joint portion of the video image of the first camera unit 100 and the video image of the second camera unit 200 is made less conspicuous. For this purpose, control is performed so that the image blur correction amounts between the camera units are each matched (step S303).

When the result of the determination in step S302 indicates that the “joint priority” mode is not selected by the user (NO), it means that the user selects the “performance priority mode” in which priority is given to the image blur correction performance for the video image of each camera unit.

The “performance priority” mode is a mode in which priority is given to that the image blur in each camera unit has been corrected by an image blur correction amount that is appropriate for each image blur, even if the video image appears unnatural because the deviation at the joint portion between video images of the respective camera units are conspicuous.

When this mode is selected, the image blur of the video image of each camera unit is corrected by each image blur correction amount by calculating each image blur correction amount based on each motion vector amount acquired by each camera unit (step S304).

That is, when it is determined in step S204 that the respective motion vector amounts are appropriate, image blur correction for a plurality of video signals can be performed by sharing any one of the motion vector amounts of the video image signals determined to be appropriate, as in step S303.

Alternatively, as in step S304, image blur correction for the plurality of video signals can be performed by using the respective motion vector amounts. That is, both can be selected. Thus, in steps S205, S206, and S301 to S304, the control step in the present embodiment is performed according to the determination result of the determination step in step S204.

FIG. 4 illustrates an example of video images from each camera unit, which are displayed adjacent to each other, in the embodiment. FIG. 4 illustrates an example in which the video image from the video signal output unit 111 of the first camera unit 100 and the video image from the video signal output unit 211 of the second camera unit 200 are displayed adjacent to each other. When the image blur correction amount is calculated by using an inappropriate motion vector amount in one of the camera units, the joint portions deviate from each other as shown by the dotted line portion in FIG. 4A, and the video image appears unnatural.

In contrast, as in the first embodiment, the image blur correction amount is calculated by using the appropriate motion vector amounts of the video signals of the respective camera units, thereby resulting in a natural video image without deviation at the joint portions as shown in FIG. 4B.

### <Second Embodiment>

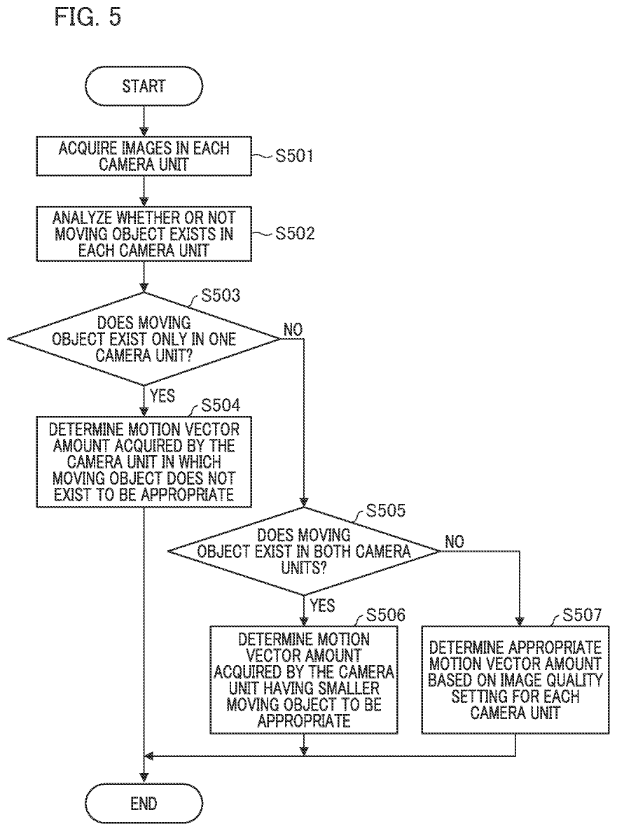

Next, FIG. 5 is a determination flowchart showing whether or not the motion vector amount of each camera unit in the second embodiment is appropriate. In the second embodiment, the determination of whether or not the motion vector amount of the video signal from each camera unit performed in step S203 is appropriate will be described with reference to FIG. 5.

In the first embodiment, the determination in S203 is made to be appropriate when at least one of the correctness, accuracy, and reliability of the motion vector is higher than a predetermined threshold. However, in the second embodiment, the motion vectors of the video signals obtained from the plurality of camera units are compared based on the predetermined determination standard, and the one having a relatively high degree of appropriateness is determined to be appropriate.

First, in step S501 in FIG. 5, images (video images) of the first camera unit 100 and the second camera unit 200 are obtained. Next, in step S502, the images are analyzed to determine whether or not a moving object exists in the video image of each camera unit obtained in step S501. In step S503, whether or not a moving object exists in the video image of one of the first camera unit 100 and the second camera unit 200 is determined.

When the result of the determination in step S503 indicates that the moving object exists only in the video image of one of the camera units (YES), the motion vector amount acquired by the camera unit in which the moving object exists in the video image is determined to be not appropriate. The motion vector amount acquired by the camera unit in which the moving object does not exist in the video image is determined to be appropriate (step S504).

Thus, in step S504, the motion vector amount of the video signal analyzed that the moving object does not exist is determined to be appropriate, and the motion vector amount of the video signal analyzed that the moving object exists is determined to be not appropriate.

In contrast, if the result is “NO” in step S503, the moving object exists in the images of both camera units, or the moving object does not exist in the images of both camera units. Therefore, in step S505, whether or not the moving object exists in the images of both the first camera unit 100 and the second camera unit 200 is determined.

When the result of the determination in step S505 indicates that the moving object exists in the images of both camera units (YES), the size of the moving object is acquired, and the motion vector amount acquired by the camera unit having a smaller moving object is determined to be appropriate (step S506).

That is, the motion vector amount of the video signal analyzed that the size of the moving object is lower than a predetermined value is determined to be appropriate, and the motion vector amount of the video signal analyzed that the size of the moving object is higher than the predetermined value is determined to be not appropriate.

In contrast, when the result of the determination in step S505 indicates that the moving object does not exist in the images of both camera units (NO), the image quality setting of each camera unit is acquired. Subsequently, which camera unit has the appropriate motion vector amount is determined based on the acquired image quality setting (step S507).

That is, for example, the motion vector of the camera unit having a higher image quality setting is determined to be appropriate.

Thus, the determination unit determines whether or not each motion vector amount is appropriate based on the analysis result of the video signals each obtained from the plurality of camera units or at least one item of the image quality setting information of the camera units.

In the above example, in step S506, although only the size of the moving object is taken into consideration as the analysis result, which motion vector is appropriate may be determined by taking into consideration the type and the movement speed of the moving object. Additionally, the ratio of the background of the moving object may be taken into consideration.

### <Third Embodiment>

FIG. 6 is a flowchart showing the confirmation of the image quality setting of each camera unit in third embodiment.

The basic flow is similar to that of first embodiment. In the first embodiment, as shown in FIG. 5, the determination as to whether or not the motion vector amount is appropriate in step S203 in FIG. 2 is performed depending on whether or not the moving object exists. However, in the third embodiment, which motion vector amount is appropriate is determined according to the image quality setting of each camera unit.

First, in step S601, the image quality settings of the respective camera units are acquired. In step S602, it is determined whether or not the image quality settings of the respective camera units acquired in step S601 are different.

When the result of the determination of the image quality setting in step S602 indicates that the image quality settings of the respective camera units are not different (NO), the motion vectors from both camera units are determined to be appropriate, and the flow of FIG. 6 ends.

When the result of the determination in step S602 indicates that the image quality settings of the respective camera units are different (YES), the process proceeds to step S603. For the camera unit having the image quality setting (for example, low image quality mode) by which an appropriate motion vector amount cannot be acquired, the motion vector amount of the camera unit having the image quality setting (for example, high image quality mode) by which the appropriate motion vector amount can be acquired is used as being appropriate.

### <Fourth Embodiment>

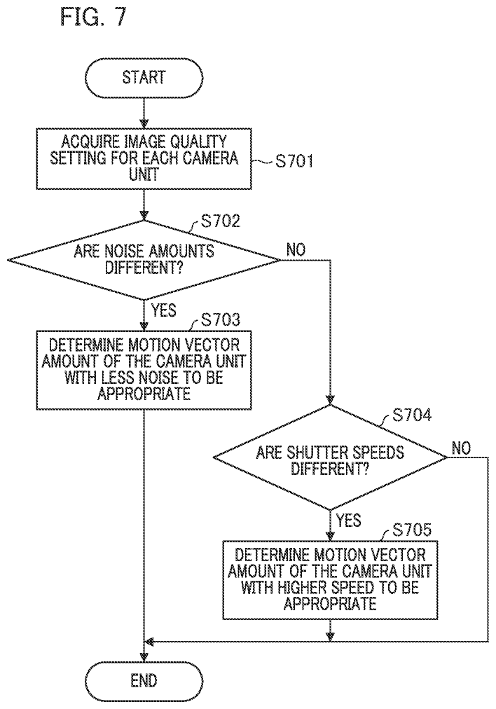

FIG. 7 is a flowchart showing the determination of an appropriate motion vector amount according to the noise amount and shutter speed of each camera unit in the fourth embodiment.

That is, in the third embodiment, although the motion vector amount of the camera unit having the image quality setting in which an appropriate motion vector amount can be acquired is determined to be appropriate, in the fourth embodiment, the appropriate motion vector amount is determined according to the amount of noise and shutter speed.

Specifically, in step S701, the image quality setting of each camera unit is acquired. Based on the image quality settings of the respective camera units acquired in step S701, whether or not the amount of noise occurring at each camera unit is different is determined (step S702). For example, when a high sensitivity mode is set as the image quality setting, a noise increases compared to a case in which a low sensitivity mode is set.

When the result of the determination in step S702 indicates that the amount of noise occurring in each camera unit is different depending on the image quality setting (YES), the motion vector amount of the camera unit having the image quality setting in which the amount of noise is reduced is set to be appropriate (step S703).

That is, the motion vector amount acquired from the camera unit having the image quality setting information indicating that the noise amount in the video signal becomes relatively low is determined to be appropriate. The motion vector amount acquired from the camera unit having the image quality setting information indicating that the noise amount in the video signal becomes relatively high is determined to be not appropriate.

In the fourth embodiment, although the determination of whether or not the noise amount is different uses the image quality setting information such as a high sensitivity mode and a low sensitivity mode, the noise amount may be acquired from an image obtained by each camera unit. If the noise amount is high, the motion vector amount is incorrectly detected, and the determination is performed based on the noise amount.

When the result of the determination in step S702 indicates that the amount of noise occurring in each camera unit is not different (NO), whether or not the shutter speed set in each camera unit is different is determined (step S704).

When the result of the determination in step S704 indicates that the shutter speed set in each camera unit is not different (NO), the motion vector amounts from both camera units are determined to be appropriate, and the flow of FIG. 7 ends.

In contrast, when the result of the determination in step S704 indicates that the shutter speed set in each camera unit is different (YES), the motion vector amount of the camera unit having the image quality setting in which the shutter speed is high is determined to be appropriate (step S705).

That is, in step S705, the motion vector amount acquired from the camera unit having the image quality setting information indicating that the shutter speed is higher than the predetermined value is determined to be appropriate. The motion vector amount acquired from the camera unit having the image quality setting information indicating that the shutter speed is lower than the predetermined value is determined to be not appropriate.

Thus, in the present embodiment, if the shutter speed is low, the motion vector amount is incorrectly detected due to the occurrence of a residue image in the image, and whether or not the motion vector amount is appropriate is determined by using the shutter speed.

### <Fifth Embodiment>

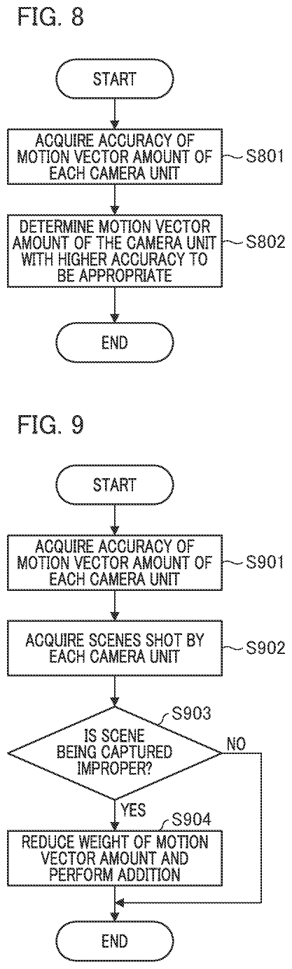

FIG. 8 is a flowchart showing the determination of an appropriate motion vector amount according to the accuracy of the motion vector of each camera unit in the fifth embodiment.

In the fifth embodiment, the motion vector amount of the camera unit in which an appropriate motion vector can be acquired is determined to be appropriate based on the accuracy information of the motion vector of each camera unit. The flow using the accuracy information of the motion vector in the fifth embodiment will be described with reference to FIG. 8.

First, the accuracy of the motion vector amount for each camera unit is acquired in step S801 in FIG. 8. Subsequently, in step S802, if the accuracy of the motion vector is higher than a predetermined threshold, the motion vector is determined to be appropriate. Subsequently, the camera in which the accuracy of the motion vector acquired in step S801 is lower than the predetermined threshold calculates an image blur correction amount by using a motion vector amount of the camera unit in which the accuracy of the motion vector is high.

That is, in step S802, the motion vector amount of which accuracy is higher than a predetermined value is determined to be appropriate, and the motion vector amount of which accuracy is lower than a predetermined value is determined to be not appropriate.

Additionally, before step S802, the determination of whether or not the difference in the accuracy of the motion vector of each camera unit is equal to or higher than a threshold is performed, and if the determination result is “YES”, the process of step S802 may be performed. If the determination result is “NO”, the motion vectors obtained from both camera units are determined to be appropriate, and the flow in FIG. 8 may end.

### <Sixth Embodiment>

FIG. 9 is a flowchart showing the weighting of motion vector for each camera unit in the sixth embodiment.

The sixth embodiment is an example of the calculation of the image blur correction amount by relatively increasing the weight of the appropriate motion vector amount or relatively reducing the weight of the inappropriate motion vector amount, based on the accuracy information of the motion vector of each camera unit.

In FIG. 9, first, in step S901, the accuracy of the motion vector amount of each camera unit is acquired. Next, the information about a scene being captured by each camera unit is acquired (step S902), and whether or not the acquired scene is an improper scene is determined (step S903). A scene that is improper for the motion vectors, such as low contrast image or dark image, and so on, is set in advance.

When the result of the determination in step S903 indicates that the scene being captured by each camera unit is not an improper scene (NO), the motion vectors from both camera units are determined to be appropriate, and the flow in FIG. 9 ends.

When the result of the determination in step S903 indicates that the scene being captured by each camera unit is improper (YES), the weight of the motion vector amount acquired by the camera unit that is capturing the improper scene is reduced (step S904).

In contrast, in the scenes that are not improper, the weight of the motion vector amount may relatively be increased. Thus, in the improper scene, the weight of the motion vector amount is relatively reduced for each camera unit, and each motion vector amount to which weighting has been performed is added.

Subsequently, the weighted-add motion vector amount is set to a shared motion vector amount, and image blur correction operation for all the camera units is performed based on the shared motion vector amount. The image blur correction amount may be calculated for each camera unit by using the respective motion vector amounts for which the weights have been relatively changed.

In the first embodiment to the fifth embodiment, the appropriate motion vector amount is shared and the image blur correction for the plurality of camera units is performed. However, even in the first embodiment to the fifth embodiment, the image blur correction amount may be calculated by relatively increasing the weight of the appropriate motion vector amount, or relatively reducing the weight of the inappropriate motion vector amount and combining them by weighted-adding or the like, as in the sixth embodiment.

That is, image blur correction for the video signals may be performed by relatively reducing the weight of the motion vector determined to be not appropriate by the determination unit and combining with the motion vector determined to be appropriate by the determination unit. That is, the motion vector determined to be not appropriate may not be used with a weight of zero, as in the examples of the first embodiment to the fifth embodiment. In other words, the weight includes zero.

### <Seventh Embodiment>

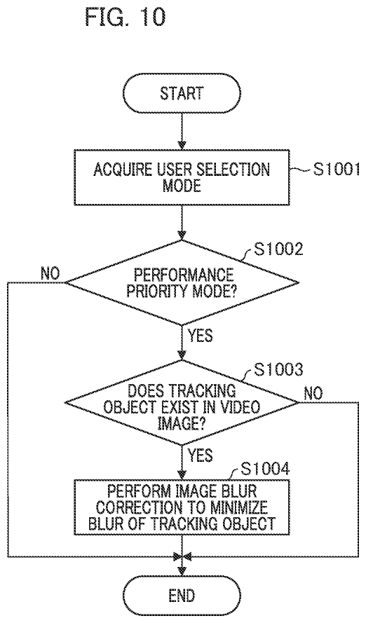

FIG. 10 is a flowchart showing the calculation of the image blur correction amount in the seventh embodiment. In the seventh embodiment, depending on the presence of a moving object (a tracking object) that is being tracked by each camera unit image, blur correction is performed by using an image blur correction amount such that an image blur of a tracking object is corrected most.

First, in step 1001 in FIG. 10, which one of the “joint priority” mode and the “performance priority” mode is selected as the user selection mode is obtained.

In step S1002, whether or not the user selection mode obtained in step S1001 is a “performance priority” mode in which priority is given to the image blur correction (image stabilization) performance (image stabilization performance) is determined.

When the determination result in step S1002 indicates that the “performance priority” mode is selected by the user (YES), whether or not the tracking object exists in the video image of each camera unit is determined (step S1003).

In contrast, when the determination result in step S1002 indicates that the “performance priority” mode is not selected by the user (NO), the flow in FIG. 10 ends.

It is determined in step S1003 that the tracking object exists in the video image of each camera unit (YES), the image blur correction amount is calculated so that blur of the tracking object is suppressed most and becomes a stationary state. Subsequently, image blur correction is performed in each camera unit by using the calculated image blur correction amount (step S1004). That is, when the moving object exists, image blur correction is performed by using the correction amount by which the image blur of the moving object is corrected most.

In contrast, when the result of the determination in step S1003 indicates that the tracking object does not exist in the screen of each camera unit (NO), the flow in FIG. 10 ends.

### <Eighth Embodiment>

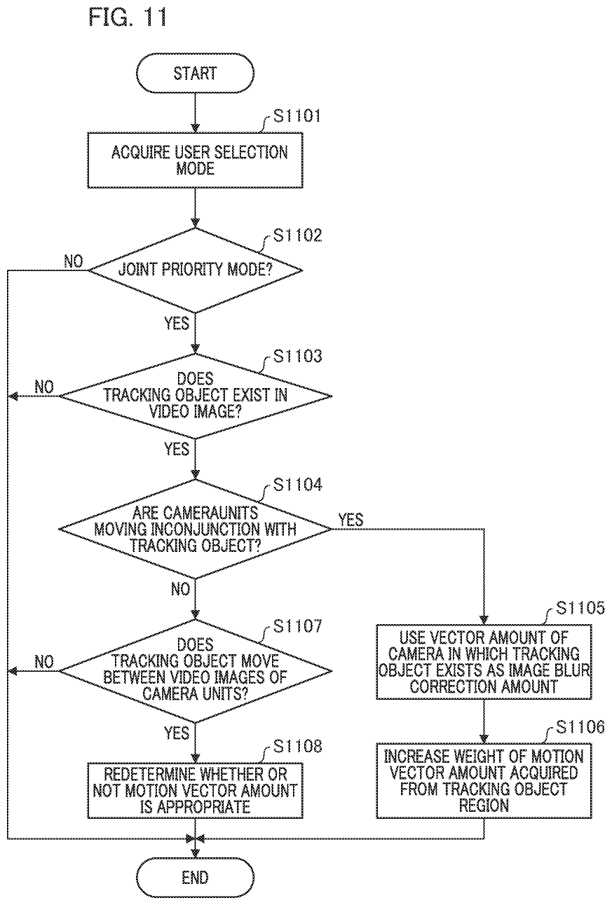

FIG. 11 is a flowchart showing the determination of the motion vector amount in the eighth embodiment. In the eighth embodiment, whether or not the motion vector amount is appropriate is determined again in response to the motion in conjunction with the motion of each camera unit and the motion of the tracking object.

First, in step S1101 in FIG. 11, which one of the “joint priority” mode and the “performance priority” mode is selected as the user selection mode is acquired.

In step S1102, whether or not the user selection mode acquired in step S1101 is the “joint priority” mode in which priority is given to inconspicuous deviation of the joint portion.

When the result of the determination in step S1102 indicates that the “joint priority” mode is selected by the user (YES), whether or not the tracking object exists in the video image of each camera unit is determined (step S1103).

In contrast, when the result of the determination in step S1102 indicates that the “joint priority” mode is not selected (NO), the flow in FIG. 11 ends.

When the result of the determination in step S1103 indicates that the tracking object exists in each camera unit (YES), whether or not each camera unit is moving in conjunction with the tracking object is determined (step S1104).

There is a method for tracking an object in which each camera unit moves to follow the motion of the object, or a frame is displayed as to match the tracking object while each camera unit is fixed and not moved.

In contrast, when the result of the determination in step S1103 indicates that the tracking object does not exist in the video image of each camera unit (NO), the flow in FIG. 11 ends.

When it is determined in step S1104 that the camera unit is moving in conjunction with the tracking object (YES), the motion vector amount of the camera unit in which the tracking object exists is used as the image blur correction amount (step S1105). Specifically, when each camera unit moves in conjunction with the moving object, the motion vector amount of the camera unit in which the moving object exists is used as the image blur correction amount.

Further, the weighting of the reliability of the motion vector amount acquired from the region where the tracking object in the video image exists is increased (step 1106). Specifically, the weighting of the motion vector amount acquired from the region of the moving object is increased.

Since the speed at which each camera unit moves is approximately the same as the speed of the tracking object, the object appears to stop at a predetermined position in the video image. Hence, since the tracking object in the video image can be recognized as an object that is in a stationary state rather than an object that is moving, the accuracy of the acquired motion vector amount is determined to be high, and the weighting is increased.

If it is determined in step S1104 that each camera unit is not moved in conjunction with the tracking object (NO), whether or not the tracking object is moving between the video images of the respective camera units is determined (step S1107).

If it is determined in step S1107 that the tracking object is not moving between the video images of the respective camera units (NO), the flow in FIG. 11 ends. In contrast, if it is determined in step S1107 that the tracking object is moving between the video images of the respective camera units (YES), in step S1108, the motion vector amount is acquired again from each camera unit and whether or not the acquired motion vector amount is appropriate is determined again.

That is, when the moving object moves between the video images of the camera units in the case where the camera units do not move in conjunction with the moving object, whether or not the motion vector amount is appropriate is determined again.

Additionally, the motion vector amount acquired from which camera unit should be used for image blur correction is determined depending on the determination result, and the update of the camera in which the image blur correction amount is to be used is performed (step S1108).

Whether or not each camera unit is moved in conjunction with the tracking object may be set by the user or may automatically be determined when the presence of the tracking object is detected.

The tracking object detected by the detection of the presence of the tracking object may be performed by selecting an object in the video image by the user or automatically selecting an object that is moving (moving object). When the object (moving object) is automatically selected, the object to be tracked may be a person or a car, or the type of the object may be selected by the user.

### <Ninth Embodiment>

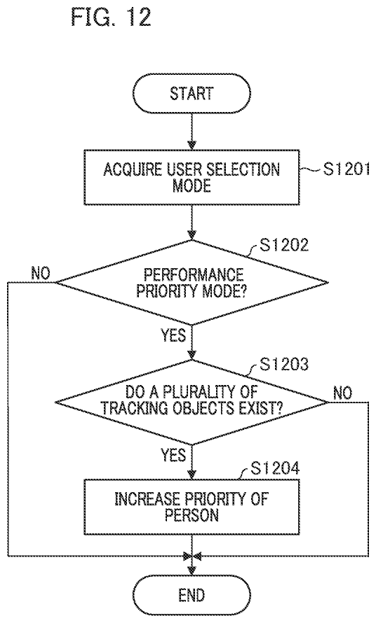

FIG. 12 is a flowchart showing the calculation of the image blur correction amount in the ninth embodiment.

In the ninth embodiment, when a plurality of tracking objects exists, the image blur of a person is corrected with higher priority. First, the user selection mode is obtained in step S1201 in FIG. 12, and whether or not the mode obtained in step S1201 is the “performance priority” mode is determined (step S1202).

When the result of the determination in step S1202 indicates that the “performance priority” mode in which priority is given to the anti-vibration performance (vibration suppression performance) is selected (YES), whether or not a plurality of tracking objects exist is determined (step S1203).

In contrast, when the result of the determination in step S1202 indicates that the “performance priority” mode is not selected (NO), the flow in FIG. 12 ends.

When the result of the determination in step S1203 indicates that a plurality of tracking objects (YES) exist, the priority level of the person is raised, and an image blur correction amount that results in image blur correction that is more effective for the person is calculated (step S1204). That is, when a plurality of moving objects exist, and if at least one of plurality of moving objects includes a person, the priority level of the motion vector of the person is raised.

When the result of the determination in step S1203 indicates that a plurality of tracking objects do not exist (NO), the flow in FIG. 12 ends.

Each of the functional blocks shown in FIG. 1 is not necessarily built in the same casing and may be configured by separate devices connected to each other via a signal path.

Further, although, in the above embodiment, the image processing apparatus 1000 includes a plurality of camera units, the image processing apparatus 1000 may not include a plurality of camera units, and may be, for example, a general-purpose computer or a server that processes video signals from a plurality of camera units.

### <Tenth Embodiment>

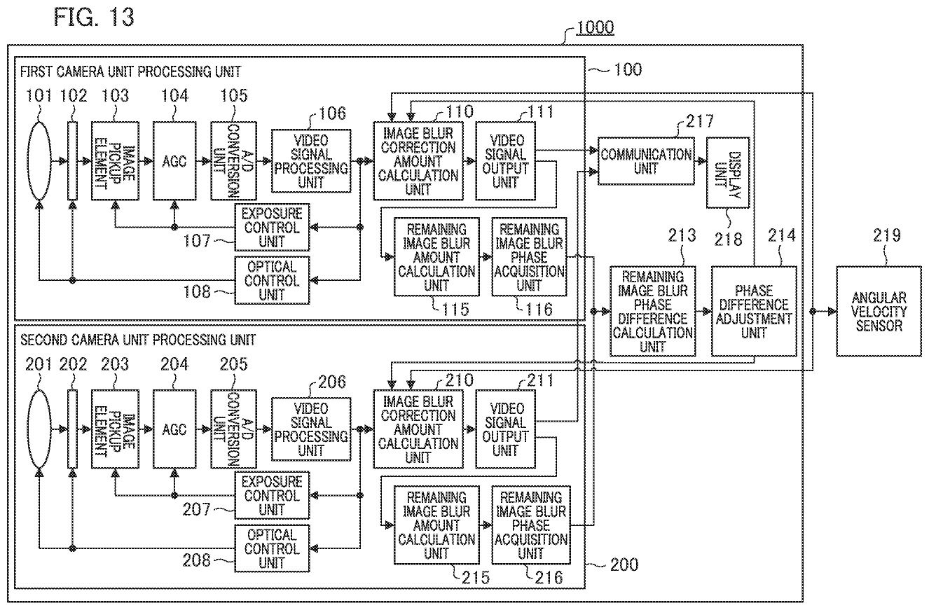

FIG. 13 is a block diagram illustrating an example of a configuration of the image processing apparatus 1000 in the tenth embodiment.

A part of the functional block shown in FIG. 13 is realized by causing a computer serving as a control unit (not illustrated) included in the image processing apparatus 1000 to execute a computer program stored in a memory serving as a storage medium (not illustrated). However, some or all of them may be realized by hardware. A dedicated circuit (ASIC), a processor (reconfigurable processor, DSP) or the like can be used as hardware.

The image processing apparatus 1000 shown in FIG. 13 includes the first camera unit 100 and the second camera unit 200. Since reference numerals 101 to 108, 110, 111, 115, and 116, which are the function block of the first camera unit 100 and reference numerals 201 to 208, 210, 211, 212, 215, and 216, which are the function block of the second camera unit 200, have the same configuration, the functional block of the first camera unit will be described mainly.

In FIG. 13, the lens group 101 of the first camera unit 100 is an optical system that condenses light incident from an object to the image pickup element 103. The lens group 101 includes a focus lens that focuses on an object, a zoom lens that adjusts an angle of view, and the like.

The object image that has entered the camera through the lens group 101 passes through the optical filter 102, such as an infrared cut filter IRCF, and is incident to the image pickup element 103.

The object image formed via the lens group 101 passes through a color filter of a predetermined pattern arranged on the light receiving surface of the image pickup element 103, is photoelectrically converted by each pixel of the image pickup element 103 and is output as an analog image signal.

The level adjustment is performed on the image signals output from the image pickup element 103 by gain control by the AGC (Auto Gain Control) 104, and the image signals are converted into digital image signals by the A/D conversion unit 105.

The video signal processing unit 106 performs predetermined processing on the digital image signals from the A/D conversion unit 105 and outputs video signals consisting of a luminance signal and a color signal, and generates various parameters for performing camera control.

The various parameters for performing camera control include parameters used for aperture control, focusing control, and white balance control for adjusting color tone.

An exposure control unit 207 calculates the luminance information in the capturing screen based on the luminance information serving as parameters that are output from the video signal processing unit 106 and controls the aperture and the AGC 104 so that the captured image is adjusted at a desired brightness.

The optical control unit 108 extracts a high-frequency component from the video image signals generated by the video signal processing unit 106 for focus control. Subsequently, the optical control unit 108 controls the lens group 101 so that the focus evaluation value is maximized, by using the value of the high-frequency component as the focus information (focus evaluation value).

The optical control unit 108 also adjusts the focus length of the lens group 101 and controls insertion and removal of the optical filter 102 according to the luminance level.

The image blur correction amount calculation unit 110 calculates an image blur correction amount by performing signal processing such as a digital filtering on angular velocity information serving as blur signals acquired from an angular velocity sensor 219. Then, according to the calculated image blur correction amount, the cut-out position (read-out region) of the video image from an image memory 409 to be described below is changed and electronic image blur correction is performed.

That is, the image blur correction amount calculation unit 110 functions as an image blur correction unit for executing the image blur correction processing in which the image blur correction for a plurality of video signals obtained by a plurality of camera units is performed by using the blur signal for each video signal.

The video signal output unit 111 outputs the video image for which electronic image blur correction has been performed in a predetermined format, transmits the video image to a display unit 218 via a communication unit 217 that performs wired or wireless communication, and supplies the video image to a remaining image blur amount calculation unit 115.

Here, the angular velocity sensor 219 functions as a shake sensor for detecting shaking and outputting a blur signal corresponding to the shaking. However, the shake sensor may be, for example, one that outputs blur signals by calculation based on the direction of the average motion vector in the video image signal and the amount of the average motion vector by the remaining image blur amount calculation unit 115.

The display unit 218 may be separate from or integrated with the image processing apparatus 1000, and video images of a plurality of image signals after image blur correction are displayed adjacent to each other.

The remaining image blur amount calculation unit 115 calculates the amount of remaining image blur occurring in the video image after electronic image blur correction output from the video signal output unit 111. That is, for example, the average value of the motion vectors of the entire screen can be used as the remaining image blur amount.

The remaining image blur phase acquisition unit 116 performs sampling to the remaining image blur amount calculated by the remaining image blur amount calculation unit 115 at a predetermined time interval, stores the result for a predetermined period, and generates waveform signals corresponding to the remaining image blur amount. Reference numerals 201 to 208, 210, 211 to 211, 215, and 216, which are the function block of the second camera unit, perform the same operation as reference numerals 101 to 108, 110, 111, 115, and 116, which are the function block of the first camera unit.

A remaining image blur phase difference calculation unit 213 compares the waveform signals corresponding to the remaining image blur amount acquired by a remaining image blur phase acquisition unit 116 of the first camera unit with the waveform signals corresponding to the remaining image blur amount acquired by a remaining image blur phase acquisition unit 216 of the second camera unit. Subsequently, the phase difference in the remaining image blur between the first camera unit and the second camera unit is calculated.

Here, the remaining image blur phase difference calculation unit 213 functions as a phase difference acquisition unit that executes a phase difference acquisition step for acquiring the phase difference in remaining image blur that remains after image blur correction for each of the video signals has been performed by the image blur correction unit.

A phase difference adjustment unit 214 calculates to what degree the phase of the digital filter should be changed based on the phase difference in the remaining image blur between the first camera unit and the second camera, which has been calculated by the remaining image blur phase difference calculation unit 213.

Subsequently, the phase of at least one of the digital filter used in the image blur correction amount calculation unit 110 of the first camera unit and the digital filter used in an image blur correction amount calculation unit 210 of the second camera unit is changed.

That is, the phase difference adjustment unit 214 functions as a phase adjustment unit that executes a phase adjustment step for aligning the phases in the remaining image blur between a plurality of video signals when the phase difference is equal to or higher than a predetermined value.

Although, in the tenth embodiment, the phase of the digital filter (phase advance or phase delay filter) is changed, a delay circuit for changing the phase of the blur correction signals may be provided.

In the tenth embodiment, a plurality of functional blocks (for example, the first camera unit 100 and the second camera unit 200) of the image processing apparatus shown in FIG. 13 are built in the same casing as the image processing apparatus. However, the plurality of functional blocks may not be built in the same casing and may be configured by separate devices connected to each other via a signal path.

That is, the plurality of camera units or the like may be separate bodies, and the image processing apparatus 1000 may be, for example, a general-purpose computer or a server that processes video signals from the plurality of camera units.

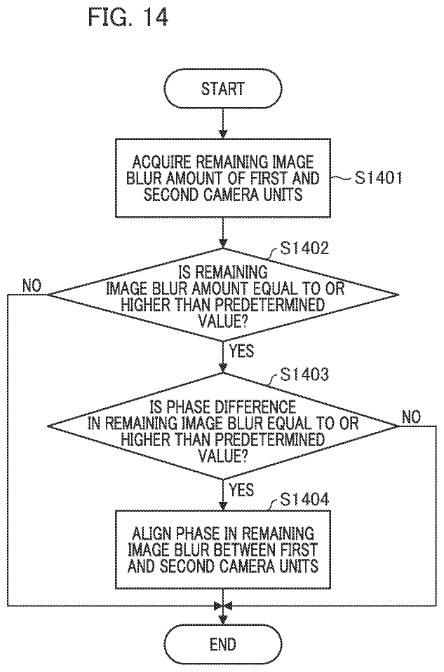

FIG. 14 is a flowchart showing the process in the tenth embodiment. Hereinafter, the alignment of phases in remaining image blur between the first camera unit and the second camera unit according to the tenth embodiment of the present invention will be described, with reference to FIG. 14.

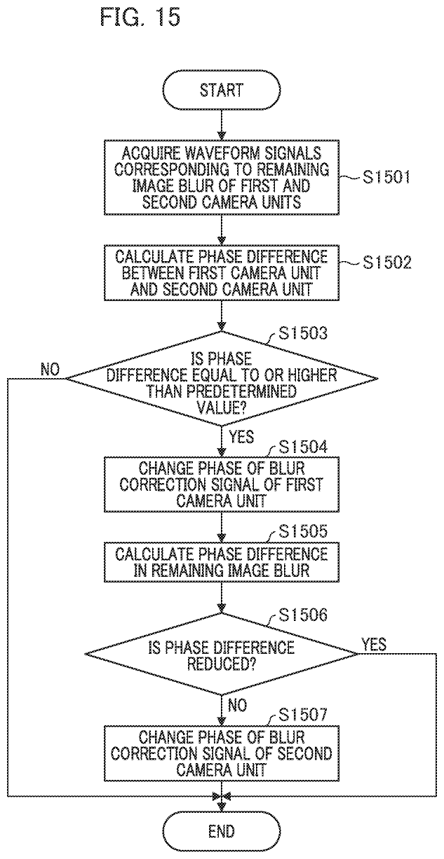

Each of the processes in the flowchart in FIG. 14 is performed by causing a computer serving as a control unit (not illustrated) included in the image processing apparatus 1000 to execute a computer program stored in a memory serving as a storage medium (not illustrated). The same applies to the flowcharts of FIG. 15 and FIG. 18 to FIG. 23.

First, in step S1401 in FIG. 14, the remaining image blur amount between the first camera unit and the second camera unit is acquired. That is, in the video image after electronic image blur correction, how much remaining image blur occurs is calculated by using, for example, a motion vector amount.

Although, in the tenth embodiment, the remaining image blur amount is calculated by using the motion vector amount, the remaining image blur amount may be calculated by using gyro signals together.

In step S1402, whether or not the remaining image blur amount calculated in step S1401 is equal to or higher than a predetermined value is determined. When the result of the determination indicates the remaining image blur amount is not equal to or higher than a predetermined value (NO), the phase alignment of between the first camera unit and the second camera unit is not performed, and the flow of FIG. 14 ends.

This is because if the remaining image blur amount is quite small, the deviation at the joint portions is quite small, less conspicuous, and not artificial, when the video images of the respective camera units are displayed arranged adjacent to each other and jointed even if the phases of the first camera unit and the second camera unit are different.

When the result of the determination in step S1402 indicates that the phase difference in remaining image blur amount equal to or higher than a predetermined value (YES), whether or not the phase difference in the remaining image blur amount between the first camera unit and the second camera unit calculated in step S1401 is equal to or higher than the predetermined value is determined (step S1403).

When the result of the determination in step S1403 indicates that the phase difference in remaining image blur amount is lower than the predetermined value (NO), the phase alignment of between the first camera unit and the second camera unit is not performed, and the flow in FIG. 14 ends.

This is because, if the phase difference is quite small, the deviation at the joint portion is quite small, less conspicuous, and not artificial, when the video images of the respective camera units are displayed arranged adjacent to each other and jointed.

When the result of the determination in step S1403 indicates the phase difference in the remaining image blur is equal to or higher than a predetermined value (YES), the phases in remaining image blur between the first camera unit and the second camera unit are aligned (step S1404). Thus, in the present embodiment, the phase adjustment unit aligns the phases in the remaining image blur for a plurality of video signals when the remaining image blur amount of the video signals is equal to or higher than a predetermined value and the phase difference is equal to or higher than the predetermined value.

However, even if the remaining image blur amounts of the video signals are not equal to or higher than a predetermined value, the phases in the remaining image blur of the video signals may be aligned when the phase difference are equal to or higher than a predetermined value.

FIG. 15 is a flowchart that explains the details of step S1403 in FIG. 14. Hereinafter, a detailed flow showing the alignment of the phases in the remaining image blur will be described with reference to FIG. 15.

First, in step S1501 in FIG. 15, the waveform signals corresponding to the remaining image blur of the first camera unit and the second camera unit are acquired. The waveform signals corresponding to the remaining image blur are generated by performing sampling to the remaining image blur amount of each camera unit at a predetermined time interval and storing the result for a predetermined time period. The predetermined time interval and the predetermined time period are appropriately changed according to an image pickup time (period), the system frequency, and the image blur frequency.

In step S1502, the waveform signals corresponding to the remaining image blur of the first camera unit and the waveform signals corresponding to the remaining image blur of the second camera unit acquired in step S1501 are compared and the phase difference in the remaining image blur of the first camera unit and the second camera unit is calculated.

In step S1503, whether or not the phase difference calculated in step S1502 is equal to or higher than a predetermined value is determined. When the result determined in step S1503 indicates that the phase difference in the remaining image blur is not equal to or higher than the predetermined value (NO), phase alignment between the first camera unit and the second camera unit is not performed, and the flow of FIG. 15 ends.

When the result determined in step S1503 indicates that the phase difference in the remaining image blur is equal to or higher than the predetermined value (YES), the phase of the blur correction signal of the image blur correction amount calculation unit 110 of the first camera unit is changed (step S1504).

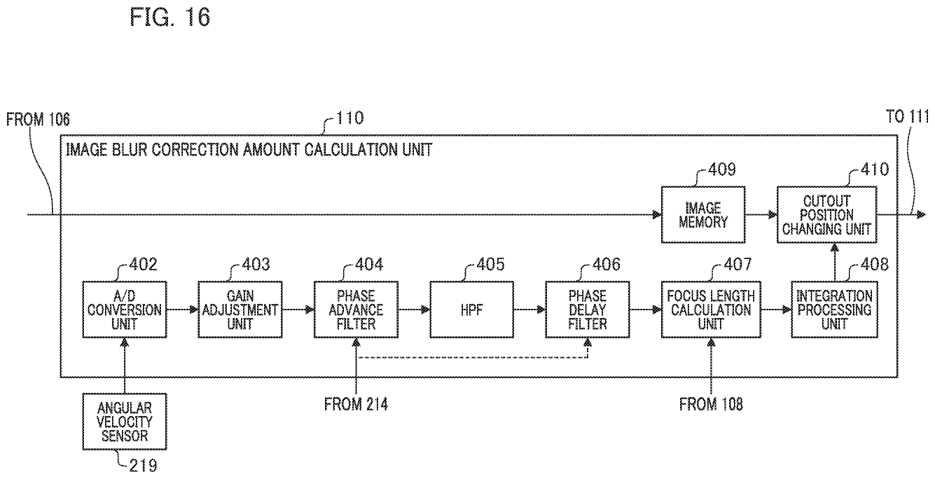

FIG. 16 is a block diagram showing an example of the detailed configuration of the image blur correction amount calculation unit. The image blur correction amount calculation units 110 and 210 in FIG. 13 acquire the shaking generated in the image processing apparatus as an angular velocity signal from the angular velocity sensor 219 and output the acquired angular velocity information as digital signals by an A/D conversion unit 402.

A gain adjustment unit 403 adjusts the amplitude of the digital signals by multiplying the digital signals output by the A/D conversion unit 402 by a predetermined coefficient.

A phase advance filter 404 is a filter for advancing the phase of the digital signals, and an HPF 405 performs filtering in a predetermined frequency band.

A phase delay filter 406 is a filter for delaying the phase for the signals on which filtering has been performed by the HPF 405. A focus length calculation unit 407 acquires focus length information of the lens group 101 from the optical control unit 108 and adjusts the signal magnitude so as to obtain an image blur correction amount corresponding to the focus length.

An integration processing unit 408 performs integration on the signals calculated by the focus length calculation unit 407 by using the LPF or the like to calculate the final image blur correction amount. The image memory 409 is a memory that temporarily stores video signals from the video signal processing unit 106.

A cutout position changing unit 410 corrects the blur in the video image by changing the cut-out position of the image stored in the image memory 409 based on the image blur correction amount and the image blur direction information obtained from the integration processing unit 408. The video image for which image blur correction has been performed is supplied to a video signal output unit 111 in a subsequent stage.

In step S1504 in FIG. 15, the phase of the blur correction signal of the first camera unit is changed by changing at least one of the phase advance filter 404 and the phase delay filter 406 in FIG. 16 based on the output of the phase difference adjustment unit 214.

However, as described above, a delay circuit or the like for changing the phase of the blur correction signal may be provided separately. Thus, in the tenth embodiment, the phases in the remaining image blur between the video signals are aligned by adjusting the phase of the blur signal for performing image blur correction for at least one of the video signals.

In step S1505, the phase difference in the remaining image blur between the first camera unit and the second camera unit after the phase of the blur correction signal of the digital filter of the first camera unit is changed is calculated again. The calculation method is the same as that performed in step S1501 and step S1502.

The phase difference in the remaining image blur of each camera unit calculated in step S1505 is compared with the phase difference in the remaining image blur of each camera unit calculated in step S1502 before changing the digital filter of the first camera unit in step S1504. Subsequently, whether or not the phase difference of each camera unit is reduced is determined (step S1506).

When the result of the determination in step S1506 indicates the phase difference between each camera unit is reduced (YES), the flow in FIG. 15 ends without further any processing.

When the result of the determination in step S1506 indicates that the phase difference between each camera unit is not reduced (YES), the process proceeds to step S1507. In step S1507, the phase of the blur correction signal is changed by changing at least one of the phase advance filter and the phase delay filter in the image blur correction amount calculation unit 210 of the second camera unit.

Although the phase of the blur correction signal of the first camera unit is changed first, the phase of the blur correction signal of the second camera unit may be changed first.

Thus, in the present embodiment, when the phase difference is equal to or higher than a predetermined value, the phase in the remaining image blur of one video signal among the plurality of video signals is adjusted, and when, after the adjustment, the remaining image blur is equal to or higher than a predetermined value, the phases in the remaining image blur of the other video signals among the plurality of video signals are further adjusted.

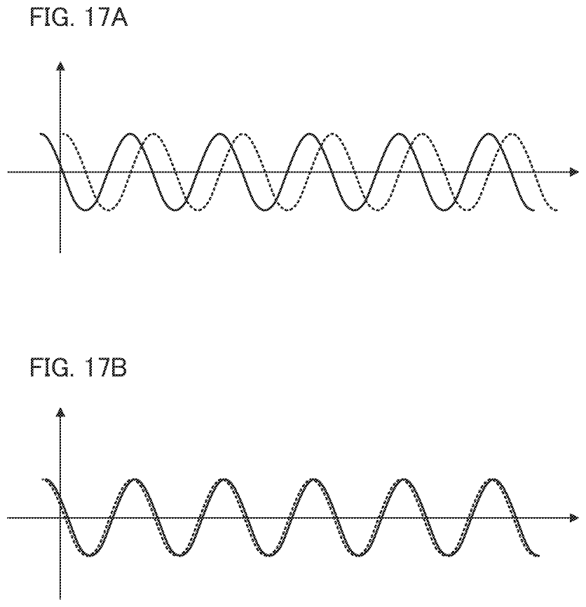

FIG. 17 illustrates an example of waveform signals corresponding to remaining image blur. The waveform signals shown by the dotted line in FIG. 17 indicates the wave signals corresponding to the remaining image blur of the first camera unit, and the waveform signals shown by the solid line in FIG. 17 indicates the wave signals corresponding to the remaining image blur of the second camera unit.

The waveform signals indicating that the phases of the camera units deviate from each other as shown in FIG. 17A results in the waveform signal indicating that the phases of the camera units align as shown in FIG. 17B by changing the digital filter of the first camera unit or the second camera.

As described above, FIG. 4 illustrates that the video images of the first camera unit and the second camera unit are displayed arranged adjacent to each other by the display unit 217. If the phase difference in the remaining image blur of each camera unit is not aligned, the joint portions deviate from each other as shown by the dotted line in FIG. 4A, and the video image appears unnatural.

In contrast, according to the present embodiment, the joint portions do not deviate from each other as shown by the dotted line in FIG. 4B and the video image appears natural, by aligning the phase differences in the remaining image blur between the respective camera units.

### <Eleventh Embodiment>

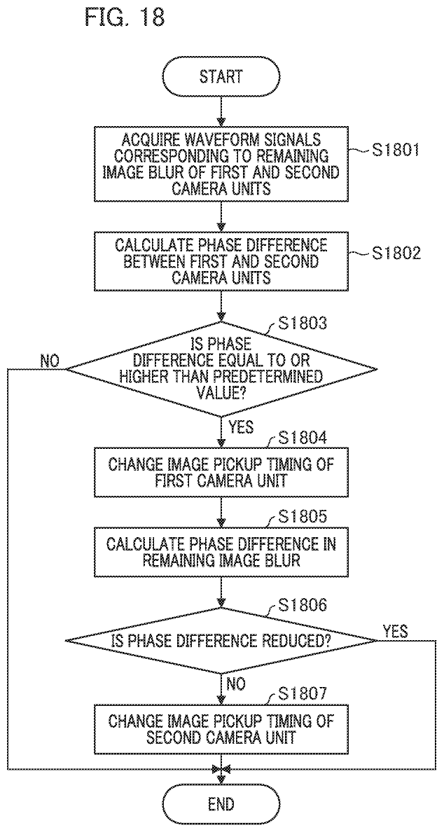

Hereinafter, the eleventh embodiment of the present invention will be described with reference to FIG. 18.

FIG. 18 is a flowchart showing the process flow of the eleventh embodiment. Steps S1801 to S1803, S1805, and S1806 are the same as steps S1501 to S1503, S1505, and S1506 in FIG. 15. First, in step S1801 in FIG. 18, the waveform signals corresponding to the remaining image blur of the first camera unit and the second camera unit are acquired. The method for acquiring the waveform signals corresponding to the remaining image blur may be the same as the method in step S1501 of the flowchart in FIG. 15 in the tenth embodiment.

A phase difference in the remaining image blur between the first camera unit and the second camera unit is calculated by comparing the waveform signals corresponding to the remaining image blur of each camera unit acquired in step 1801 (step S1802).

In step S1803, whether or not the phase difference calculated in step S1802 is equal to or higher than the predetermined value is determined. When the result of the determination in step S1803 indicates that the phase difference in the remaining image blur is not equal to or higher than a predetermined value (NO), the phase alignment of between the first camera unit and the second camera unit is not performed, and the flow in FIG. 18 ends.

When the result of the determination in step S1803 indicates that the phase difference in the remaining image blur is equal to or higher than a predetermined value (YES), the image pickup timing of the first camera unit is changed (step S1804).

In step S1805, the phase difference in the remaining image blur between the first camera unit and the second camera unit after the change of the image pickup timing of the first camera unit is calculated again. The calculation method is the same as that performed in steps S1801 and S1802.

Whether or not the phase difference between each camera unit is reduced is determined by comparing the phase difference in the remaining image blur of each camera unit calculated in step S1805 with the phase difference in the remaining image blur of each camera unit calculated in step S1802 (step S1806).

When the result of the determination in step S1806 indicates that the phase difference between each camera unit is reduced (YES), the process ends without any further processing.

When the result of the determination in step S1806 indicates that the phase difference between each camera unit is not reduced (NO), the image pickup timing of the second camera unit is changed (step S1807). Although, in the above explanation, the image pickup timing of the first camera unit is changed first, the image pickup timing of the second camera unit may be changed first.

Thus, in the eleventh embodiment, the phase adjustment unit aligns the phases in the remaining image blur between the video signals by adjusting the image pickup timing of at least one of the camera units.

### <Twelfth Embodiment>

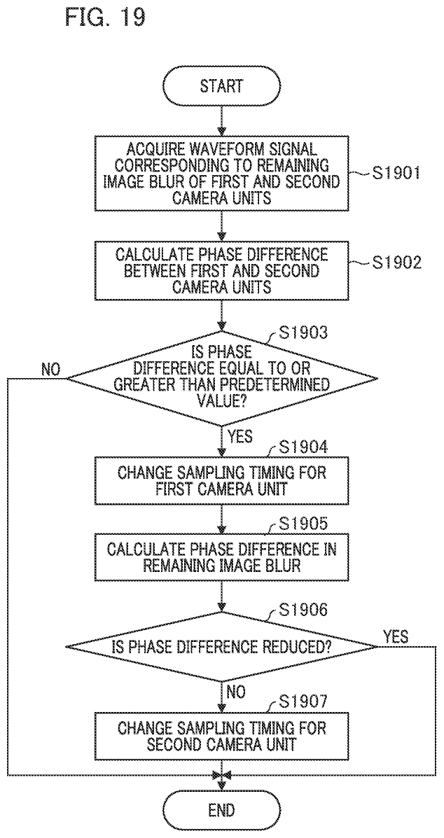

FIG. 19 is a flowchart showing the process in the twelfth embodiment. In FIG. 19, since steps S1901 to S1903, S1905, and S1906 are the same as steps S1801 to S1803, S1805, and S1806 in FIG. 18, descriptions thereof are partially omitted.

In the twelfth embodiment, the sampling timing that acquires the gyro signals, which are the output of the angular rate sensor, is changed for aligning the phase of each camera unit.

That is, in FIG. 19, when the result of the determination of the phase difference in the remaining image blur between the first camera unit and the second camera unit in step S1903 indicates that the phase difference in the remaining image blur is equal to or higher than a predetermined value (YES), the process proceeds to step S1904.

Then, in step S1904, the phase difference between the camera units is aligned by changing the sampling timing that acquires the gyro signals serving as the blur signals of the first camera unit.

Further, if, in step S1906, the phase difference is not reduced, in step S1907, the sampling timing that acquires the gyro signals of the second camera unit is changed.

Thus, in the twelfth embodiment, the phases in the remaining image blur between the video signals are aligned by changing the sampling timing of the output of the angular velocity sensor serving as the blur signals for performing image blur correction on at least one of the video signals.

### <Thirteenth Embodiment>

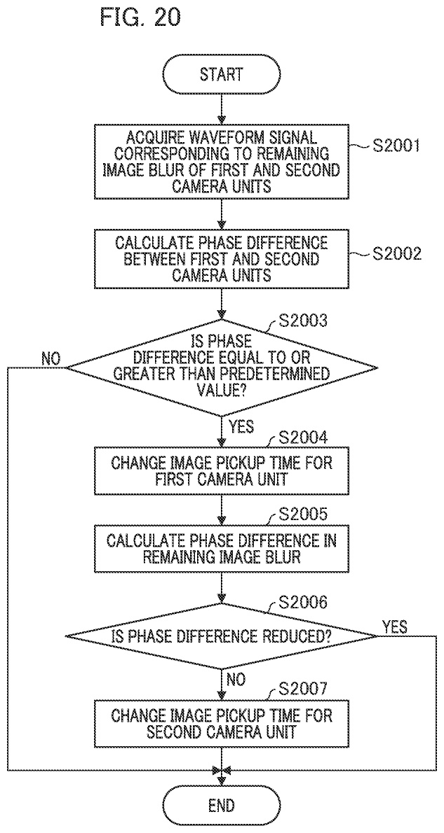

FIG. 20 is a flowchart showing the process in the thirteenth embodiment. In FIG. 20, since steps S2001 to S2003, S2005, and S2006 are the same as steps S1901 to S1903, S1905, and S1906 in FIG. 19, descriptions thereof are partially omitted.

In the thirteenth embodiment, the image pickup time (period) is changed for aligning the phase of each camera unit. Here, the image pickup time (period) can be changed by changing the shutter speed of a mechanical shutter or by changing the storage time of the image pickup element. Alternatively, both may be combined and changed.

In FIG. 20, when the result of the determination in step S2003 regarding the phase difference in the remaining image blur between the first camera unit and the second camera unit indicates that the phase difference in the remaining image blur is equal to or higher than a predetermined value (YES), the process proceeds to step S2004. In step S2004, the phase difference between the camera units is aligned by changing the image pickup time (period) of the first camera unit.

Furthermore, if, in step S2006, the phase difference is not reduced, in step S2007, the image pickup time (period) of the second camera unit is changed so that the phase difference between each camera units is aligned.

Thus, in the thirteenth embodiment, the phase adjustment unit aligns the phases in the remaining image blur between the video signals by adjusting the image pickup time (period) of at least one of the camera units.

### <Fourteenth Embodiment>

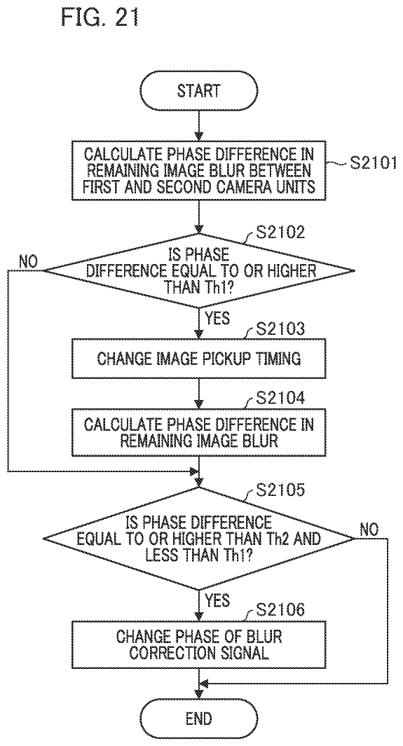

FIG. 21 is a flowchart showing the process in the fourteenth embodiment.

In the tenth embodiment to the thirteenth embodiment, only the phase of the blur correction signals, the image pickup timing, and the image pickup time (period) are changed so that the phase difference in the remaining image blur between the camera units is aligned. However, in the fourteenth embodiment, both the image pickup timing and the phases of the blur correction signals are changed according to the phase difference in the remaining image blur.

First, in step S2101, the phase difference in the remaining image blur between the first camera unit and the second camera unit is calculated. In step S2102, whether or not the calculated phase difference is equal to or higher than the first threshold (Th1) is determined.

When the result of the determination in step S2102 indicates that the phase difference is not equal to or higher than the first threshold (NO), the process proceeds to step S2105.

In contrast, when the result of the determination in step S2102 indicates that the phase difference is equal to or higher than the first threshold (YES), in step S2103, the image pickup timing of the first camera unit or the second camera unit is changed first.

After the image pickup timing is changed in step S2103, the phase difference in the remaining image blur between the first camera unit and the second camera unit is calculated again in step S2104, and the process proceeds to step S2105.

In step S2105, whether or not the phase difference in the remaining image blur is equal to or lower than the first threshold, equal to or higher than the second threshold (Th2), and lower than the first threshold (Th1) is determined. Here, Th2<Th1 is defined.

When the result of the determination in step S2105 indicates that the phase difference in the remaining image blur is equal to or higher than the second threshold and lower than the first threshold (YES), the process proceeds to step S2106. In step S2106, the phase of the blur correction signal is changed by a digital filter used for image blur correction in the first camera unit or the second camera unit. If the result is “NO” in step S2105, the flow in FIG. 21 ends without any further processing.

### <Fifteenth Embodiment>

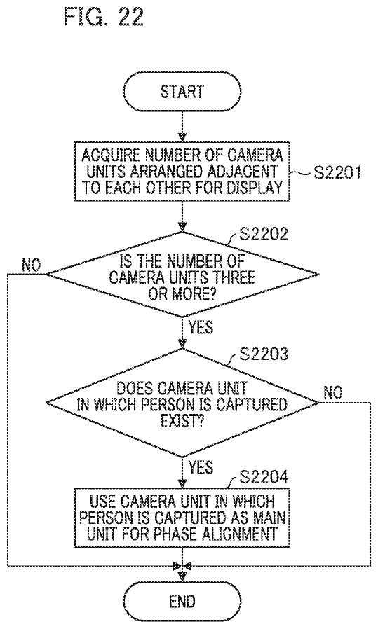

FIG. 22 is a flowchart showing the process in the fifteenth embodiment. In the tenth embodiment to the fourteenth embodiment, the case in which the number of camera units used for display arranged adjacent to each other is two is explained as an example. However, in the fifteenth embodiment, if the number of camera units used for display arranged adjacent to each other is three or more, a camera unit to be mainly used for phase alignment is determined.

First, in step S2201, the number of camera units used for display arranged adjacent to each other is obtained. Whether or not the number of obtained camera units is three or more is determined (step S2202), and when the result of the determination indicates that the number of camera units is not three or more (NO), the flow in FIG. 22 ends without any further processing.

When the result of determination in step S2202 indicates that the number of camera units is three or more (YES), whether or not a camera unit in which a person is in the image exists is determined (step S2203).

When the result of the determination in step S2203 indicates that a camera unit in which a person is in the image exists (YES), the phases of the other camera units are adjusted to align with the phase of to the camera unit in which the person is in the image (step S2204).

When the result of the determination in step S2203 indicates that a camera unit in which a person is in the image does not exist, the process ends without any further processing. In the fifteenth embodiment, when video images of three or more camera units are displayed adjacent to each other, the phase of the other camera units are aligned with the phase of the camera unit in which a person is captured.

However, when a specific object is specified in advance, the phases of the other camera units may be aligned with the phase of the camera unit in which the specific object is in the image.

Furthermore, even when the video images of the two camera units are displayed adjacent to each other, the phase of the other camera unit may be aligned with the phase of the camera unit in which the specific object is in the image.

Thus, in the present embodiment, when the phase difference is equal to or higher than a predetermined value, the phase adjustment unit adjusts the phase in the remaining image blur of the other video signal to align with the phase in the remaining image blur of one video signal among the video signals. Additionally, the phase adjustment unit adjusts the phase in the remaining image blur of the other video signal to align with the phase in the remaining image blur of the video signal in which a predetermined object is captured from among the video signals.

### <Sixteenth Embodiment>

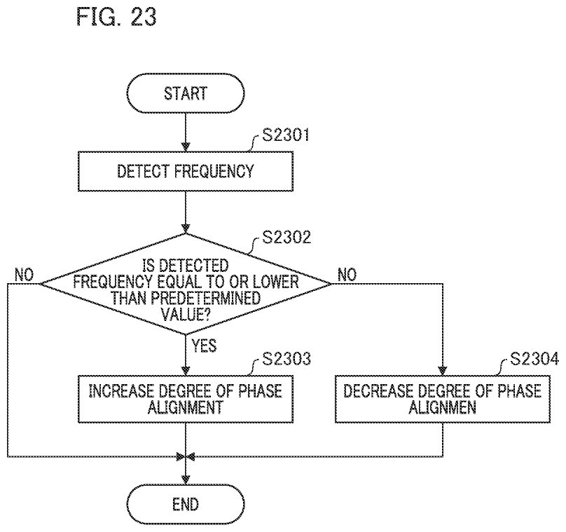

FIG. 23 is a flowchart showing the process in the sixteenth embodiment. In the sixteenth embodiment, the frequency of shaking (vibration) occurring in the camera unit is detected by the angular velocity sensor 215 or the like serving as a shake sensor, and the intensity of the phase alignment is changed according to the frequency.

First, in step S2301, the frequency of the shaking (vibration) occurring in the camera unit is detected based on the blur signal obtained from the angular velocity sensor 219 or the like serving as the shake sensor. In step S2301, whether or not the detected frequency of the shaking (vibration) is equal to or lower than a predetermined frequency is determined (step S2302).

When the result of the determination in step S2302 indicates that the detected frequency of the shaking (vibration) is equal to or lower than the predetermined frequency (YES), in step S2303, the degree of phase alignment is increased. That is, the phase is made to be further aligned.

In contrast, when the result of the determination in step S2302 indicates that the frequency of the detected shaking (vibration) is higher than the predetermined frequency (NO), in step S2304, the degree of phase alignment is reduced.

While the present invention has been described with reference to exemplary embodiments, it is to be understood that the invention is not limited to the disclosed exemplary embodiments. The scope of the following claims is to be accorded the broadest interpretation to encompass all such modifications and equivalent structures and functions.

In addition, as a part or the whole of the control according to this embodiment, a computer program realizing the function of the embodiment described above may be supplied to the image processing apparatus through a network or various storage media. Then, a computer (or a CPU, an MPU, or the like) of the image processing apparatus may be configured to read and execute the program. In such a case, the program and the storage medium storing the program configure the present invention.

This application claims the benefit of Japanese Patent Applications No. 2021-103255 filed on Jun. 22, 2021, No. 2021-212556 filed on Dec. 27, 2021, No. 2021-102904 filed on Jun. 22, 2021, No. 2022-6392 filed on Jan. 19, 2022, all of which are hereby incorporated by reference herein in those entireties.

What is claimed is:

1. An image processing apparatus comprising:
at least one processor or circuit configured to function as:
an acquisition unit configured to acquire each of motion vector amounts of video signals each obtained from a plurality of camera units;
a determination unit configured to determine whether or not each of the motion vector amounts is appropriate; and
a control unit configured to perform image blur correction for the video signal for which the motion vector amount determined to be not appropriate has been obtained by using the motion vector amount determined to be appropriate if it is determined by the determination unit that at least one of the motion vector amounts is not appropriate, and to perform image blur correction for the plurality of video signals by sharing any one of the motion vector amounts determined to be appropriate by the determination unit or perform image blur correction for the plurality of video signals by using the respective motion vector amounts if it is determined by the determination unit that the respective motion vector amounts are appropriate.

2. The image processing apparatus according to claim 1, wherein if the difference between each of the motion vector amounts each acquired by the acquisition unit is equal to or higher than a predetermined value, the determination unit determines whether or not each of the motion vector amounts is appropriate.

3. An image processing apparatus comprising:
at least one processor or circuit configured to function as:
an acquisition unit configured to acquire each of motion vector amounts of video signals each obtained from a plurality of camera units;
a determination unit configured to determine whether or not each of the motion vector amounts is appropriate; and
a control unit configured to perform image blur correction for the video signals by relatively reducing the weight of the motion vector amount determined to be not appropriate by the determination unit and by combining with the motion vector amount determined to be appropriate by the determination unit.

4. The image processing apparatus according to claim 3, wherein if each of the motion vector amounts is determined to be appropriate by the determination unit, the control unit performs image blur correction for the video signals by sharing any one of the motion vector amounts determined to be appropriate by the determination unit, or performs image blur correction for the video signals by using each of the motion vector amounts.

5. The image processing apparatus according to claim 1, wherein the determination unit determines whether or not each of the motion vector amounts is appropriate based on a result of analyzing the video signals each obtained from the camera units or image quality setting information of the camera units.

6. The image processing apparatus according to claim 5, wherein the determination unit determines that the motion vector amount of the video signal analyzed that a moving object does not exist to be appropriate and determines that the motion vector amount of the video signal analyzed that the moving object exists to be not appropriate.

7. The image processing apparatus according to claim 5, wherein the determination unit determines that the motion vector amount of the video signal analyzed that the size of the moving object is lower than a predetermined value to be appropriate, and determines that the motion vector amount of the video signal analyzed that the size of the moving object is higher than the predetermined value to be not appropriate.

8. The image processing apparatus according to claim 6, wherein the analysis result of whether or not the moving object exists includes at least one of a type and a moving speed of the moving object.

9. The image processing apparatus according to claim 5, wherein the determination unit determines that the motion vector amount acquired from a camera unit having image quality setting information indicating that a noise amount in the video signal is relatively low is appropriate and determines that the motion vector amount acquired from a camera unit having image quality setting information indicating the noise amount in the video signal is relatively high is not appropriate.

10. The image processing apparatus according to claim 5, wherein the determination unit determines that the motion vector amount acquired from a camera unit having image quality setting information indicating that a shutter speed is higher than a predetermined value is appropriate and determines that the motion vector amount acquired from a camera unit having image quality setting information indicating that the shutter speed is lower than the predetermined value is not appropriate.

11. The image processing apparatus according to claim 1, wherein the determination unit determines that the motion vector amount having accuracy that is higher than a predetermined value is appropriate and determines that the motion vector amount having accuracy that is lower than the predetermined value is not appropriate.

12. The image processing apparatus according to claim 1, wherein if each of the motion vector amounts is determined to be appropriate by the determination unit, a user selects whether image blur correction for the plurality of video signals is to be performed by sharing any one of the motion vector amounts determined to be appropriate by the determination unit or by using the respective motion vector amounts.

13. The image processing apparatus according to claim 1, wherein if each camera unit moves in conjunction with a moving object, the motion vector amount of a video signal in which the moving object exists is used as an image blur correction amount.

14. The image processing apparatus according to claim 13, wherein the weighting of the motion vector amount acquired from the region of the moving object is increased.

15. The image processing apparatus according to claim 13, wherein if each camera unit does not move in conjunction with the moving object, and when the moving object moves between video signals of camera units, the determination unit determines again whether or not the motion vector amount is appropriate.

16. The image processing apparatus according to claim 1, wherein if a moving object exists, image blur correction is performed by using a correction amount by which the most effective blur correction is performed to the moving object.

17. The image processing apparatus according to claim 16, wherein if the moving object includes a plurality of moving objects, and if at least one of plurality of moving objects includes a person, the priority of the motion vector of the person is increased.

18. An image processing method comprising the steps of:
acquiring each of motion vector amounts of video signals each obtained from a plurality of camera units;
determining whether or not each of the motion vector amounts is appropriate; and
performing control so that image blur correction is performed for the video signal for which the motion vector amount determined to be not appropriate has been obtained by using the motion vector amount determined to be appropriate if it is determined by the determination unit that at least one of the motion vector amounts is not appropriate, and so that image blur correction is performed for the plurality of video signals by sharing any one of the motion vector amounts determined to be appropriate by the determination unit or perform image blur correction for the plurality of video signals by using the respective motion vector amounts if it is determined by the determination unit that the respective motion vector amounts are appropriate.

19. A non-transitory computer-readable storage medium configured to store a computer program comprising instructions for executing following processes:
acquiring each of motion vector amounts of video signals each obtained from a plurality of camera units;
determining whether or not each of the motion vector amounts is appropriate; and
performing control so that image blur correction is performed for the video signal for which the motion vector amount determined to be not appropriate has been obtained by using the motion vector amount determined to be appropriate if it is determined by the determination unit that at least one of the motion vector amounts is not appropriate, and so that image blur correction is performed for the plurality of video signals by sharing any one of the motion vector amounts determined to be appropriate by the determination unit or perform image blur correction for the plurality of video signals by using the respective motion vector amounts if it is determined by the determination unit that the respective motion vector amounts are appropriate.

20. An image processing apparatus comprising:
at least one processor or circuit configured to function as:
an image blur correction unit configured to perform image blur correction for each of a plurality of video signals obtained by a plurality of camera units;
a phase difference acquisition unit configured to acquire a phase difference in remaining image blur that remains after image blur correction has been performed on each of the plurality of video signals by the image blur correction unit; and
a phase adjustment unit configured to align phases in the remaining image blur between the video signals if the phase difference is equal to or higher than a predetermined value.

21. The image processing apparatus according to claim 20, wherein the phase adjustment unit aligns the phases in the remaining image blur of the video signals if a remaining image blur amount of the video signals is equal to or higher than a predetermined value.

22. The image processing apparatus according to claim 20, wherein the phase difference acquisition unit calculates the phase difference in the remaining image blur by using a waveform signal corresponding to the remaining image blur.

23. The image processing apparatus according to claim 20, further including a shake sensor that detects shaking and outputs an blur signal corresponding to the shaking,
wherein the image blur correction unit performs image blur correction by using the blur signal acquired from the shake sensor, for each of the video signals.

24. The image processing apparatus according to claim 23, wherein the phase adjustment unit adjusts the phase of the blur signal for performing image blur correction for at least one of the video signals.

25. The image processing apparatus according to claim 23, wherein the phase adjustment unit adjusts a sampling timing of the blur signal for performing image blur correction for at least one of the video signals.

26. The image processing apparatus according to claim 20, wherein the phase adjustment unit adjusts an image pickup timing of at least one camera unit from among the camera units.

27. The image processing apparatus according to claim 20, wherein the phase adjustment unit adjusts an image pickup time of at least one camera unit from among the camera units.

28. The image processing apparatus according to claim 20, wherein the phase adjustment unit adjusts the phase in the remaining image blur of one video signal from among the video signals if the phase difference is equal to or higher than the predetermined value, and further adjusts the phase in the remaining image blur of another video signal from among the video signals if, after the adjustment, the remaining image blur is equal to or higher than the predetermined value.

29. The image processing apparatus according to claim 20, wherein if the phase difference is equal to or higher than the predetermined value, the phase adjustment unit adjusts the phase in the remaining image blur of another video signal in accordance with the phase in the remaining image blur of one video signal from among the video signals.

30. The image processing apparatus according to claim 29, wherein if the phase difference is equal to or higher than the predetermined value, the phase adjustment unit adjusts the phase in the remaining image blur of another video signal in accordance with the phase in the remaining image blur of a video signal in which a predetermined object is captured from among the video signals.

31. The image processing apparatus according to claim 20, further including a shake sensor that detects shaking and outputs a blur signal,
wherein a degree for aligning phase differences is changed in accordance with a frequency of the blur signal output by the shake sensor.

32. The image processing apparatus according to claim 31, wherein if the detected frequency is equal to or lower than a predetermined frequency, the degree of aligning phase difference is increased.

33. The image processing apparatus according to claim 32, wherein if the detected frequency is higher than a predetermined frequency, the degree of aligning phase difference is decreased.

34. An image processing method comprising the steps of:
performing image blur correction for a plurality of video signals obtained by a plurality of camera units;
acquiring a phase difference in remaining image blur that remains after image blur correction for each of the plurality of video signals has been performed in the performing image blur correction; and
aligning the phases in the remaining image blur of the video signals if the phase difference is equal to or higher than a predetermined value.

35. A non-transitory computer-readable storage medium configured to store a computer program comprising instructions for executing following processes:
performing image blur correction for a plurality of video signals obtained by a plurality of camera units;
acquiring a phase difference in remaining image blur that remains after image blur correction for each of the plurality of video signals has been performed in the performing of image blur correction; and
aligning the phases in the remaining image blur of the video signals if the phase difference is equal to or higher than a predetermined value.
